(19) United States
(12) Patent Application Publication
(10) Pub. No.: US 2014/0010577 A1
(43) Pub. Date: Jan. 9, 2014

(54) METHOD FOR FORMING A MULTI-COLOUR IMAGE

(71) Applicant: Xeikon I.P.B.V., GZ Eede (NL)

(72) Inventors: Jurgen Devlieghere, Borgerhout (BE); Herman Van de Straete, Deurne (BE); Paul Vrindts, Olen (BE)

(21) Appl. No.: 13/933,908

(22) Filed: Jul. 2, 2013

(30) Foreign Application Priority Data
Jul. 4, 2012 (EP) 12175006.1

(51) Int. Cl. G03G 15/01

(52) U.S. Cl. CPC G03G 15/01
USPC 399/302

(57) ABSTRACT

A method and electrostatographic printer for forming a multi-color image on a web-fed receptor material. The method includes receiving a toner image on a first toner image-collecting device in a first color unit; transferring the toner image images on the first image-collecting device at a single transfer point to the final toner image-collecting device in a final colour unit; and transferring the toner image or images collected on the final toner-image collecting device in the array of at least two image-collecting devices directly or indirectly to the receptor material at a single transfer point at one side of the receptor element using a transfer device such that the collected toner image transferred from the final toner image-collecting device using the transfer device contain the individual images from all image-forming stations in the multiple colour units, wherein at least one of the image-collecting devices is a seamless belt.

### TECHNICAL FIELD OF THE INVENTION

The present invention is related to a colour image reproduction system wherein a developed image is transferred from an image-forming member to a receptor material via at least one intermediate transfer member.

### BACKGROUND OF THE INVENTION

Electrostatographic printing operates according to the principles and embodiments of non-impact printing as described, e.g., in “Principles of Non-Impact Printing” by Jerome L Johnson (1986)—Palatino Press—Irvine Calif., 92715 USA).

Electrostatographic printing includes electrographic printing in which an electrostatic charge is deposited image-wise e.g. by ionography, on a dielectric recording member as well as electrophotographic printing in which an overall electrostatically charged photoconductive dielectric recording member is image-wise exposed to conductivity increasing radiation producing thereby a toner-developable charge pattern on the recording member.

In high speed electrostatographic printing the exposure is derived almost always from electronically stored, i.e. computer-stored information.

In the electrophotographic art, an electrostatographic single-pass multiple station multi-colour printer is known, in which an image is formed on a photoconductive belt or drum and is then transferred to a paper receiving sheet or web whereon the toner image is fixed, whereupon the web is usually cut into sheets containing the desired print frame.

In an alternative printer, toner images are transferred to a belt from distinct image-forming stations and are then transferred to the receiving sheet or web and fixed thereon.

U.S. Pat. No. 3,694,073 disclosed an electrostatographic printer for forming an image onto a web. The printer comprises a plurality of toner image-producing stations each comprising a photoconductive drum as an electrostatic image element, onto which a toner image can be formed, means for forming an electrostatic latent image on each drum and a developing unit for depositing toner onto the electrostatic latent image to render the image visible and transferable. The printer further includes means for conveying a web past the image-producing stations and transfer means for transferring the toner image on the drum onto the web.

In the printing art, the number of basic colours that are used to compose a multi-colour image is typically at least 4. CMYK systems are often used with Cyan, Magenta, Yellow and black as basic colours.

The advantages of using more than 4 basic colours are well-known. Colours not realizable with 4-colour systems can be obtained using additional colours such as Orange. Furthermore, an additional colour White can be used as a layer under other colours to eliminate the effect of the colour of the final substrate or to print on transparent substrates. Also, specific colours can be printed with a toner or ink which already has the right colour rather than making up the specific colour from basic colours, resulting in a more accurate and often cheaper way to print the specific colour.

JP 2005-338424A1 discloses an image forming apparatus where a variety of image formation are performed by using a plurality of developing devices, and which outputs a high-quality image at high speed without lowering speed not only in image formation in six colors but image formation in four colors by when setting a mode other than a six-color designating mode such as a four-color designating mode according to an instruction from the outside (user), the action of an intermediate transfer member where a two-color image forming means is arranged is stopped. In this case, control to separate an intermediate transfer roller is performed. JP 2005-338424A1 is FIG. 1 exemplifies the use of an intermediate transfer belt 51 collecting two toner images and depositing on the four toner images collected on intermediate transfer belt 50 before transfer to the recording material, but is silent in respect of the stiffness of the two intermediate seamless transfer belts, the process speed capability and the colour registration capability.

US 2011/116838A discloses an electrophotographic engine comprising: a) a series of electrophotographic modules including one or more multi-development stations and a primary imaging member; b) an inverter to invert a receiver sheet to allow the receiver sheet to be printed in a duplex mode; c) a diverter to allow a receiver sheet to enter the inverter; d) a second diverter that would allow the imaged receiver sheet to exit the electrophotographic engine with the simplex imaged side facing up. FIGS. 8E and 8F in US 2011/116838A exemplify the use of two intermediate seamless transfer belts served by 4 and 3 and 5 and 3 toner image-forming stations respectively. US 2011/116838A is silent in respect of the stiffness of the intermediate seamless transfer belts, the colour registration capability and process speed capability.

US 2010/0310285A1 discloses an image forming apparatus comprising: a first image forming unit which includes a first image carrier and is configured to form a toner image on the first image carrier; a first intermediate transfer member configured to carry the toner image primarily transferred from the first image carrier; a second image forming unit which includes a second image carrier and is configured to form a toner image on the second image carrier; a second intermediate transfer member configured to carry the toner image primarily transferred from the second image carrier; an execution unit configured to execute an operation to cause the second image forming unit to form an image while the first image forming unit is forming an image; a secondary transfer unit configured to transfer the toner image from the first intermediate transfer member to the second intermediate transfer member such that the toner image formed on the first intermediate transfer member is superposed on the toner image formed on the second intermediate transfer member; and a tertiary transfer unit configured to transfer the toner image formed on the second intermediate transfer member by the secondary transfer unit onto a recording material from the second intermediate transfer member. In an image forming apparatus using an intermediate transfer tandem method, image forming unit is divided into two parts and toner images superimposed on an intermediate transfer belt included in one of the image forming unit is once secondary transferred onto toner images superimposed on an intermediate transfer belt included in the other image forming unit and then the secondary transferred images are collectively transferred (tertiary transferred) onto a recording material at once. US 2010/0310285A1 is silent in respect of the use of five or more image-forming units, the stiffness of the two intermediate seamless transfer belts, the colour registration capability and the process speed capability.

JP 2005-338150A1 discloses a multicolour image-forming apparatus having two photosensitive drums and two intermediate transfer bodies in which color application is controlled and the number of times that primary transfer is carried out on each of the intermediate transfer bodies is reduced, but is silent in respect of the stiffness of the two intermediate seamless transfer belts, the colour registration capability and the process speed capability.

Using more basic colours also imposes some challenges. A typical technique which avoids dependence on the receptor material is to collect the different coloured toner images on a collecting device such as a drum or a seamless belt to avoid dependence on the characteristics of the receptor material. If a seamless belt is used this is typically made of a stiff material with a variation inn printing due to stretching thereof being typically less than 20 μm.

In systems where the image is collected on a collecting device such as a drum or seamless belt, the more image-producing stations present, the bigger this collecting device has to be. This affects the cost as well as the risks involved in both the production and use of such collecting device.

Furthermore, as a result of the inability of typical developer stations to be able to transfer its image to the photoconductive carrier an any angular position because of the chance of leakage, the geometry of a big collecting device becomes more challenging the bigger it becomes, certainly if the image-forming stations are uncoupled from the collecting device when they are not being used.

### SUMMARY OF THE INVENTION

An objective of the present invention is to realise a print engine configuration (printer) capable of printing images comprising a large number of coloured toner sub-images (more than with the traditional four coloured toners) in registration within 50 μm (preferably within 20 μm and particularly preferably within 10 μm) at high process speeds e.g. above 60 mm/s and preferably up to 3 m/s.

One solution to this problem would be to have multiple collecting devices, each with 1 or more print stations. These collecting devices can then each transfer the resulting image of its print stations to the receptor material, e.g. the paper. Using techniques to ensure registration between the images of the various collecting devices, the result can be a full colour image. However, if the final receptor material is a more flexible, e.g. on a web, the registration of the images of the multiple collecting devices thereon proves to be very difficult. Any variation in web tension results in variation in speed and length of the material. The fact that the different colours transferred from different intermediates are not transferred at the same place to the passing web means that any difference in web speed directly results in inter-colour registration defects. This has an effect on the colour printed because of the incorrect placing of the basic colours in the screening.

A model has been developed to simulate the observed dependence of registration upon print engine configuration. Xeikon's current commercial print engine configuration, e.g. that of the Xeikon 8000, with the traditional four colours ameliorates variability in registration by printing without a collecting device directly on the receptor material, but registration problems occur between the first and last colour printed in the case of very flexible substrates. Very flexible receptor materials (print media) with unstable tension conditions exhibit bad registration quality. This was shown experimentally. These experimental results could be simulated using this model in which the tension condition varied over time at the transfer point.

This problem can be solved by using a collecting device, but such collecting devices (intermediate members) need to be of limited length to avoid the high production costs of such collecting devices and mechanical problems in their use. Moreover, where there is a need to print a large number of colours (more than the traditional four colours), a collecting device of limited length being too small to accommodate the large number of colours. Therefore, this problem cannot be solved by all image-producing stations depositing partial images on the same collecting device, and the resulting image being transferred in a single transfer to the receptor material. This means that for collecting multiple toner images, particularly in the case of collecting more than four toner images, multiple collecting devices have to be contemplated. The above-mentioned model has been used to establish the way in which alternative multiple collecting device options influence colour registration where there is a need to print a large number of colours.

It has been surprisingly discovered, despite the registration problems inherent in using more than one collecting device, that this problem can be solved by not all image-producing stations depositing partial images on the same collecting device, and the resulting image being still transferred in a single transfer to the receptor material. Having two or more collecting devices, each with one or more image-producing stations results in a multiplicity of smaller collecting devices. Adding a transfer zone where the partly formed image on a first collecting device is transferred to the next collecting device results in an image that can contain the images of all image-producing stations on all collecting devices. At the last collecting device the full image is present and can then be transferred to the receptor material.

This means that the registration between the different coloured toner sub-images is already fixed as soon as the last colour is added to the last collecting device. In the final transfer step towards the receptor material variations in speed tension condition in the receptor material etc. have no effect on the final registration i.e. cannot change the registration quality.

Therefore, the present invention, has the considerable advantage of combining insensitivity to the properties of the receptor material (i.e. does not require complicated sensors, actuators etc.) with a toner image-collecting device for electrostatographic printers with more than four different toners, which is not prohibitively large and not too expensive to produce.

Of course the choice of collecting device still plays an important role, but these can be selected and tuned by the engine manufacturer, and are preferably of stiff material such that the registration variations during printing do not exceed 20 μm.

The above objective is accomplished by an electrostatographic printer and method of forming a multi-colour image on a receptor material according to the present invention.

According to a first aspect of the present invention a method of forming a multi-colour image on a web-fed receptor material (13) is provided with a system comprising an array of at least two toner image-collecting devices (11) with at least a first toner image-collecting device and a final toner-image-collecting device optionally with at least one toner image-collecting device in between, said first toner-image-collecting device coming into contact with said final toner-image-collecting device or the next toner-image-collecting device in the array and the next toner-image-collecting device either coming into contact with following toner-image-collecting device in said array or said final toner-image-collecting device in said array, each toner image-collecting device being comprised in a colour unit (60) with at least one image-forming station (14) directly associated therewith that can transfer a toner image to said associated toner image-collecting device, a transfer zone (19) between a toner image-collecting device in a particular colour unit and a toner image-collecting device directly associated with a different colour unit (60), comprising the steps of: receiving the toner image or images on said first toner image-collecting device in a first colour unit (60); transferring said toner image or toner images on said first toner image-collecting device at a single transfer point either directly or via at least one intermediary toner image-collecting device each in a colour unit (60) to said final image-collecting device in said array of at least two toner image-collecting devices directly or indirectly to said receptor material from said final toner image-collecting device at a single transfer point on one side of said receptor element using a transfer device (18) such that the collected toner image transferred in said transfer zone contains the individual images from all image-forming stations in said multiple colour units, wherein at least one of the image-collecting devices (11) is a seamless belt having an overall stiffness in the range of 1×10⁻² to 1×10⁻⁶N/m.

According to a second aspect of the present invention an electrostatographic printer is provided for forming an image onto a receptor element, which printer comprises: an array of at least two toner image-collecting devices with at least a first collecting device and a final collecting device optionally with at least one collecting device in between, said first collecting device coming into contact with said final collecting device or the next collecting device in the array and the next collecting device either coming into contact with the following collecting device in said array or said final collecting device in said array, each collecting device being capable of receiving the toner images produced by a set of at least two electrostatographic stations directly associated therewith via a transfer means for transferring the toner image from each directly associated image-producing electrostatographic station in said set to said directly associated collecting device together, if applicable, with the cumulated toner images from the preceding collecting device; each set of electrostatotographic stations comprising:

a) rotatable endless surface means onto which a toner image can be formed,
b) means for forming an electrostatic latent image on the endless surface means and
c) a developing unit for depositing electrostatically charged toner particles onto the electrostatic latent image,
wherein said final collecting device is capable of transferring the cumulated toner images from the directly preceding collecting device together with the toner images received from the set of electrostatographic stations directly associated with said final collecting device to said receptor element or to an intermediate means from which later the toner image is transferred to the receptor material in which case the image is transferred indirectly to said receptor material; and wherein said printer is capable of printing images with at least five coloured toners at a process speed of greater than 60 mm/s with a registration of better than 100 μm.

The method of the first aspect of the present invention and the printer of the second aspect of the present invention are equally suitable for simplex and duplex printing. Indeed the compact nature of the printer lends itself to application in simultaneous duplex printing.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1: A typical image-forming station.

FIG. 2: Colour unit (60) is exemplified with two image-forming electrophotographic stations in contact with the toner-image-collecting device.

FIG. 3: A schematic representation of the transfer of the toner images from a single toner image collecting device to the receptor material.

FIG. 4: A general schema of the motion control, where SP is setpoint, PID is PID controller, A is amplifier, MT is motor torque, DP is prove position and PD is print dynamics.

FIG. 5: Physical modelling of the print dynamics, where IR is idler roller, SC is scorotron, TR is transfer roller. I is idler and D-Y is drum Y.

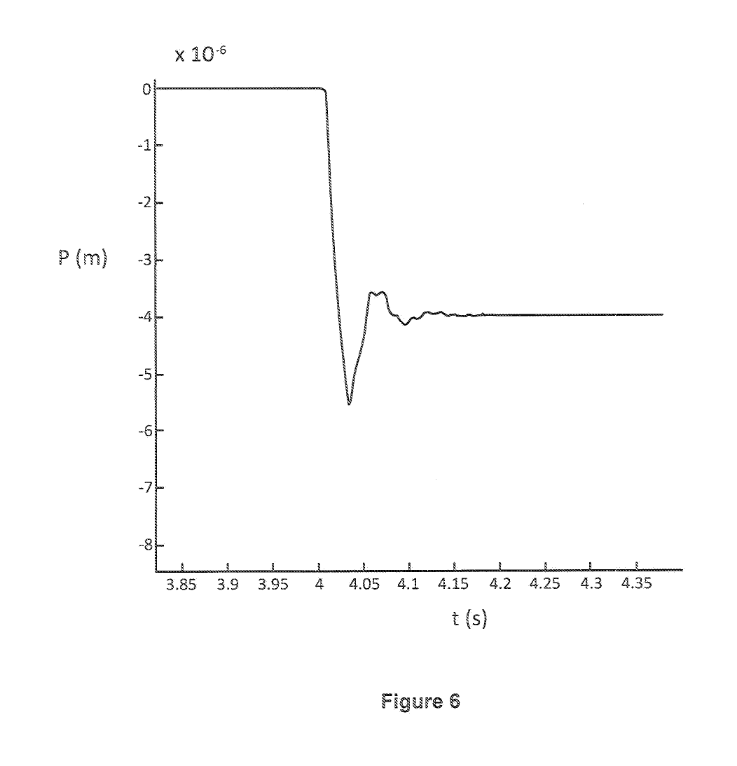

FIG. 6: Position difference, P, as a function of time, t, due to applying a force to the belt via a disturbance means.

FIG. 7: Restoration of colour registration to the original level exemplified with a plot of webline position error, WPE, as a function of scanline, S for registration of K with respect to Y.

FIG. 8: A schematic representation of transfer of the toner images from two separate toner image collecting devices to the receptor material.

FIG. 9: Inter-tower registration error, E, build-up as a function of scanline, S, upon using two seamless belt modules each in contact with the receptor material.

FIG. 10: Inter-tower registration represented as error in webline position, WPE, as a function of scanline, S, exemplifying the stress condition of the receptor material at the different belt-receptor transfer points: a) K1-K2; b) M1-K2); c) C1-K2; d) Y1-K2; e) K2-K1; f) M2-K1; g) C2-K1; and h) Y2-K1.

FIG. 11: A schematic representation of transfer of the toner images from two connecting toner image collecting devices to the receptor material according to the present invention.

FIG. 12: Embodiment with two toner image collecting devices.

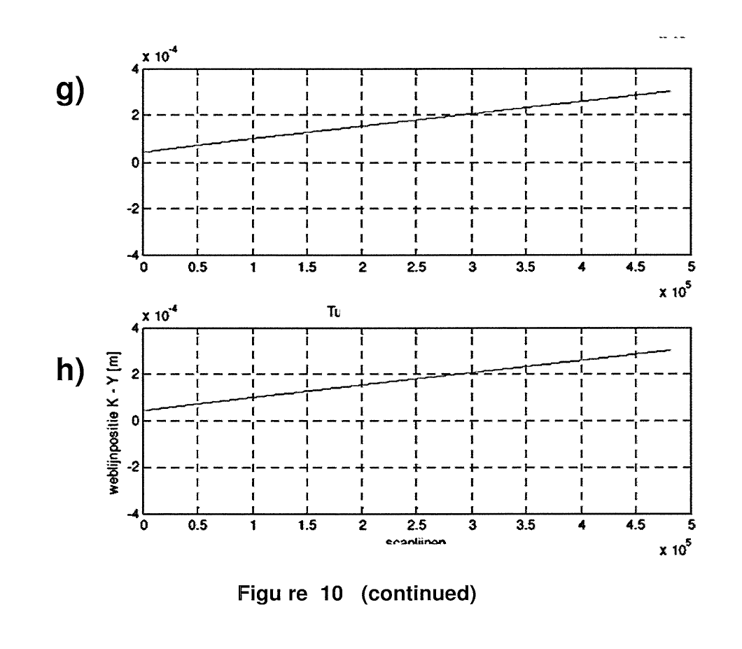

FIG. 13: Embodiment with three toner image collecting devices.

FIG. 14: Embodiment with three toner image collecting devices with fewer transfers.

FIG. 15: Embodiment with two toner image collecting devices with top transfer.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B. The meaning of the word “comprising” encompasses all the specifically mentioned features as well as optional, additional, unspecified ones, whereas the term “consisting of” only includes those features as specified in the claim. Therefore, “comprising” includes the term “consisting of”, so that the amendment from the former into the latter term does not extend beyond the content of the application as originally filed.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The following terms are provided solely to aid in the understanding of the invention.

### DEFINITIONS

The term “connecting”, as used in disclosing the present invention, includes touching, and separation of up to 200 μm (preferably up to 100 μm and particularly preferably up to 50 μm).

The term “connected collecting device”, as used in disclosing the present invention means that two toner image collecting devices are in contact with one another, such that toner images can be transferred from at least a first toner-image collecting device to a second toner image collecting device. For example two toner image collecting devices could have a common contact area at which toner image transfer can take place.

The term coloured toner, as used in disclosing the present invention, means a toner having a different colour which includes black and transparent toners which may or may not have a visually perceptible colour i.e. in the case of no colour are “colourless”.

The term process speed, as used in disclosing the present invention, means the actual printing speed.

The term colour registration, as used in disclosing the present invention, is the displacement of the individual coloured toner images (from printing station 14) in the final toner image from exact registration of the individual coloured toner images in the final toner image in the printing direction as measured with the benefit of registration marks. The registration error can be positive or negative i.e. the coloured toner image is printed before or after the exact position in the final image.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims. Other arrangements for accomplishing the objectives of the invention will be obvious for those skilled in the art.

### Modelling of Relationship Between Print Engine Configuration and Colour Registration

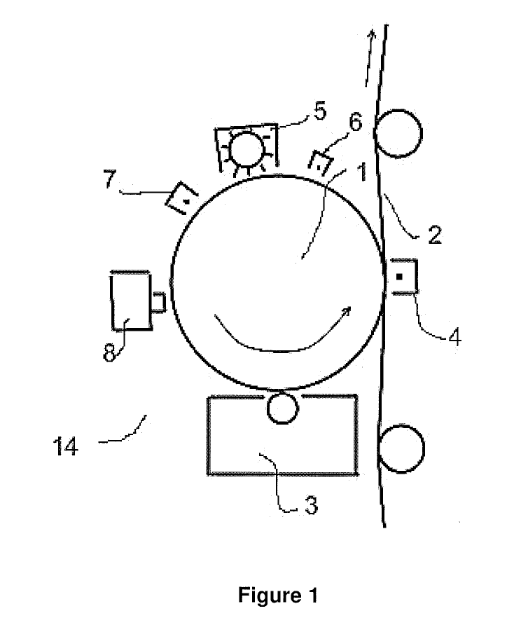

FIG. 1 shows the components of a typical image-forming station. The photosensitive medium (1) rotates, in a circular or other movement that allows the photosensitive medium to pass the various parts of the image-forming station. At a particular position in the image-forming station the photosensitive medium passes a charging device (7), which could, for example, be a corona wire or a charging roller, which is placed at a potential that puts charges on the photosensitive medium. The photosensitive medium next passes a light emitting device (8). This device could be a laser or a set of LED's or other light emitting components. The light emitting device (8) emits the light in a pattern that corresponds at least partly to the image to be formed in the colour of the print station. In another embodiment, the light emitted is the reverse of the image to be formed in that colour. The result of the light shining on any place on the photosensitive medium is that the amount of electrical charge on the place where the light is received changes, which results in an image-wise pattern of charges on the photosensitive medium called an electrostatic latent image.

While rotating, the photosensitive medium (1) next passes an image-developing unit (3). The image developing unit (3) brings the toner of the colour of the image-forming station into contact or near contact with the photosensitive medium (1) in a development zone. In that development zone, the toner is in a charged state, resulting in an image-wise transfer of toner towards the photosensitive medium.

While rotating, the photosensitive medium (1) next passes a toner image-collecting device (2) which it contacts. In the contact zone, on the other side of the toner image-collecting device, a transfer charge device (4) is placed so that the charged toner on the photosensitive drum is attracted towards the transfer charge device (4) and hence moves to the toner image-collecting device (2). The movement of the charged toner towards the transfer charge device is called electrophotographic transfer. The transfer charge device could be a corona wire, or a shielded corotron also known as a scorotron. Another embodiment uses a roller. An electric potential is applied to the transfer charge device so as to attract the charged toner thereby enabling it to be transferred from the photosensitive drum to the toner image-collecting device (2).

While rotating, the photosensitive medium typically can also pass a discharging device (6) to remove charge on the surface of the photosensitive medium and charge on the toner that was not transferred to the collecting device (2). The photosensitive medium next passes a cleaning device (5) that removes any residual toner from the photosensitive medium.

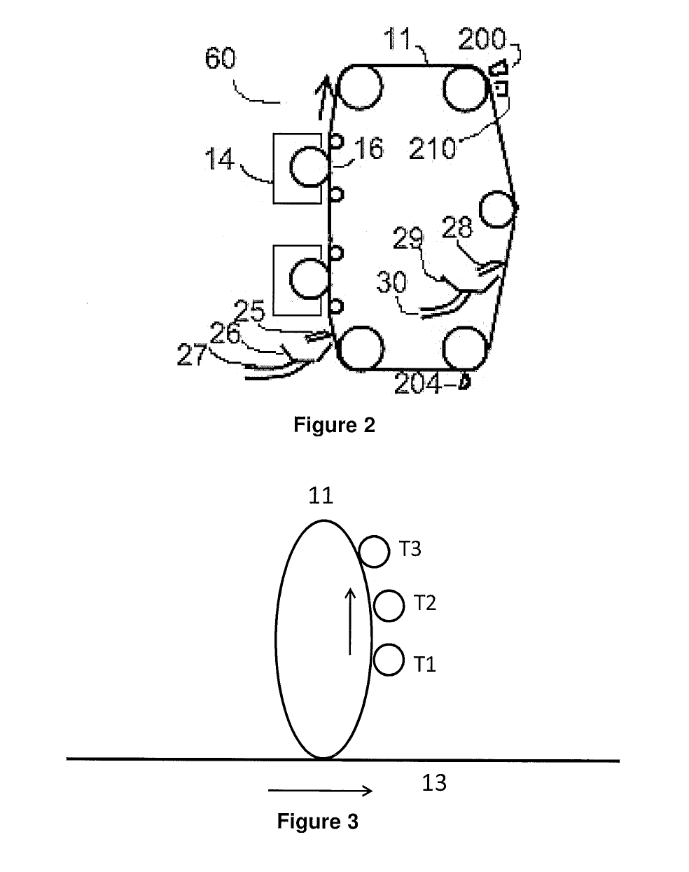

FIG. 2 exemplifies a colour unit (60) with two image-forming electrophotographic stations. A colour unit contains a toner image-collecting device (11) and at least one image-forming electrophotographic station (14), each in contact with the said toner image-collecting device. In the contact zone (16), a transfer device (4) allows the image to be transferred from the image-forming electrophotographic station to the toner image-collecting device. Having more image-forming electrophotographic stations has the advantage of having more colours of toner that can be used to form the final image.

Since each image-forming electrophotographic stations is in contact with a toner image-collecting device, putting all image-forming electrophotographic stations on a one toner image-collecting device requires the toner image-collecting device to become larger in circumference. This poses more challenges and higher cost to produce, and more difficulties to handle. Therefore the invention provides a way of having more image-forming electrophotographic stations without resulting in a toner image-collecting device that is too large.

This results in a composite image on the toner image-collecting device that is formed out of the images produced by the image-forming electrophotographic stations.

According to the invention, there are preferably at least two colour units, each with one toner image-collecting device. Each of the toner image-collecting devices is or can be in contact with multiple image-forming electrophotographic stations (14), each forming an image-wise toner image in a specific colour. Multiple image-forming electrophotographic stations can produce the same colour, but each image-forming electrophotographic station produces only one colour. That way, each toner image-collecting device collects the image of at least one colour, and collects the images of the image-forming electrophotographic stations by electrophotographic transfer from the image-forming electrophotographic stations to the collecting device.

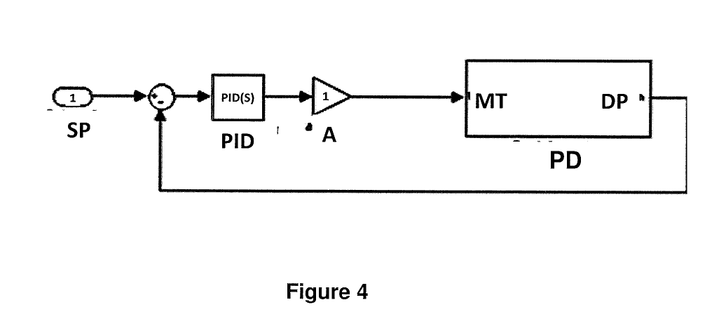

FIG. 3 shows a schematic representation of the transfer of three toner images, T1, T2 and T3 from a single toner image collecting device to the receptor material.

One of the key aspects in the evaluation of print quality is the registration between the different colours making up the image. For a print engine with different print stations, one for each colour, the colours are inherently created at different moments in time, and are collected at either an intermediate medium, or at their final destination the receptor material (print medium).

Once formed, there is no way of modifying the position of a colour: the trajectory up to the receptor material is considered as a known and fixed path. However, in reality, there are some influences that make the trajectory to the receptor material variable. In a time triggered printing principle, any speed variations result in positional differences of the colours. Moreover, if any intermediate transportation member or the final receptor material has a variable stretch status (or different tension) and then relaxes to the original stretch status, the position of the printed image on that receptor material also changes. In most cases the cause of the stretch is a force or tension. If this is the case, the result is a displacement, which is inversely proportional to the stiffness of the receptor material. An infinitely stiff receptor material would react to varying disturbance forces without changing the position of the colour image. Therefore, a print engine featuring several long image colour trajectories has preferably very constant and stable speed control, and consists of stiff components.

With perfect speed and tension control of all components in the system any print engine concept could realize printing with good registration results. However, the effort required to arrive at that perfect speed and tension control can vary considerably from one print engine concept to another. The choice of print engine concept including process speed determines how much effort is required to achieve good registration results.

In the print engine concept it is very important to consider, which components in the system add most uncertainty. In the case of a print engine, it is clear that the receptor material applied by the user is not (or is less) perfectly known by the machine control, unless a multitude of sensors is used.

A simulation study was performed of the influence of receptor material on the registration between two independent belts and the effect of speed-regulated and couple-regulated drive control at different process speeds using MATLAB® software from the company MATHWORKS. The problem was split into two parts: the dynamics of the rollers/belt/receptor material system; and the printing process.

A time simulation was performed of the dynamics of the rollers/belt/receptor material system, driven by the motors and disturbed by e.g. a force, e.g. from a scraper, on a roll. The great advantage is that non-linear aspects, such as the limitations of the motors, can be added to the model. This provides the movements of the rollers as a function of time. At least as interesting are the modal analysis (vibration eigen frequency) and frequency analysis (Bode plots) of the systems obtained. It was established that if the position/speed control functions well, the zero points of the transfer function motor couple→motor speed is reflected in the vibratory behaviour of the system.

A study was carried out of how the different roll positions as a function of time translated into a registration error in the printed image. The Magenta-encoder is used as master. This results in plots as a function of the position of the magenta line.

### Modelling the Print Dynamics:

The dynamics of the mechanical system have been modelled by a mass-spring systems with a roll or drum represented by an equivalent mass

$${m}_{eq} = \frac{J}{{r}^{2}} ,$$

where J is the inertia and r is the radius; and a belt as a spring

$${k}_{i} = \frac{E \cdot b \cdot d}{{l}_{i}}$$

where E is Young's modulus, b is the width, d is the thickness and lᵢ is the length of the piece of belt in parallel with a viscous damping.

In order also to take into account the multi-layer belt case, the determining property of the belt for the registration is the overall stiffness of the belt per unit width, which is defined as the force F needed to expand elastically a piece of belt of unit width b divided by the corresponding relative expansion.

Stiffness=E*d=[(F/b)/Δl/l)]

where Δl/l the relative expansion (increase in length Δl of the belt compared to the initial length l).

For a homogeneous belt, this stiffness per unit width equals the product of the material's Young's Modulus and its thickness. For multi-layer belts, which can be considered as parallel springs, this overall stiffness per unit width equals the sum of all stiffnesses of the individual layers. The overall stiffness of belt=ΣₜEₜ*dₜ, where i is the number of layers in the belt.

The positions and speeds were measured by ideal sensors and used as output from the model “BELTMODULE.mdl”, in a similar way to that is described in “Modeling the effects of belt compliance, backlash and slip on web tension and new methods for decentralized control of web processing lines” by Ramamurthy V. Dwivedula, submitted to the Faculty of the Graduate College of the Oklahoma State University in partial fulfillment of the requirements for the Degree of Doctor of Philosophy, December 2005.

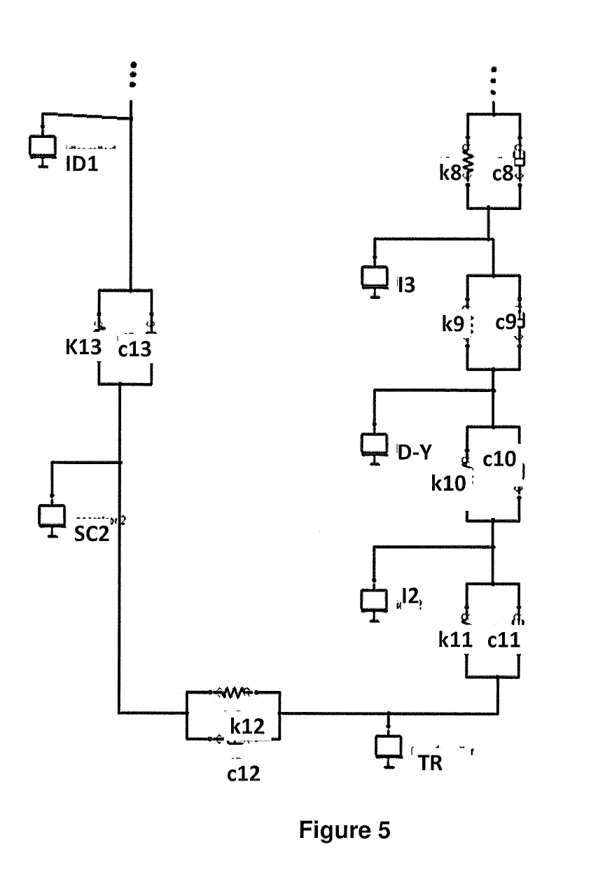

The engine control process as a whole is represented in a higher level script, see FIG. 4 which shows a general schema of the motion control, where IR is idler roller, SC is scorotron, TR is transfer roller, I is idler and D-Y is drum Y.

The engine control within the engine control process is represented here by a simple PI-speed control with encoder on the motor shaft itself (co-located control).

### Modelling of the Print Process:

In the modelling of the print process, the position of the printed lines has been modelled as close as possible to the real situation. From the “magenta” position a time stamp signal called 4FLcan be obtained:

4FLpulse1=interp1(positionM_tower1.signals.values,positionM_tower1.time,linenumber*21e-6) (1)

Then the position on the 4FL time stamps is determined for all the rollers by interpolating the positions that resulted from the first phase i.e. the print dynamics analysis:

drumlinepositionK1=interp1(positionK_tower1.time,positionK_tower1.signals.values,4FLpulse1) (2);

This is also the case for the respective drum positions of the associated colour lines.

The colours are transferred to the belt, which is a stretching medium. The starting point is that the position on the belt is normalized to the nominal stretch condition with respect to a chosen reference line on the belt. This forms a sort of absolute position for each colour line on the belt. The difference from the position at nominal stretch condition is given by the formula:

$$Δ pixel\_nom = Δ pixel * ( 1 - \frac{{ɛ}_{pre} + {ɛ}_{post}}{2} ) \qquad ( 3 )$$

where ∈ represents the stretching of the medium. This stretching is derived from the positional differences of the respective rollers:

$${ɛ}_{voor} ( t ) = \frac{{x}_{1} ( t ) - {x}_{2} ( t )}{L}$$

where L is the distance between the rollers 1 and 2. Integration of these differences in formula (3) executed by a function called “stretching” provides the positional deviation of the n^{th} scan line with respect to the normalised reference position on the belt. The drum position is thus corrected for this:

flexlinepositionK1=drumlinepositionK1−stretching(lineposition_scor1,drumlinepositionK1,linepositon_idler1,13,14) (4);

The last step is to include the delay between the print stations, as they are positioned at some distance along the image collecting device moving at a given printing speed. Registration is then obtained from the differences from the calculated positions for each individual toner (e.g. colour if a coloured toner).

A rough calculation of the effect of the stretching correction shows that an increase in tension of 10 Newton causes a stretching of 6×10⁻⁵ in the belt and thus it takes 1/(6×10⁻⁵)=16,700 scan lines at 1200 dpi=35 cm for a pixel shift to occur. At a printing speed of about 30 cm/s this corresponds to frequencies lower than 1 Hz. Thus if a disturbance means (e.g. a scraper) applies a higher force over a period of several seconds, the time difference between the colours will result in an observable effect.

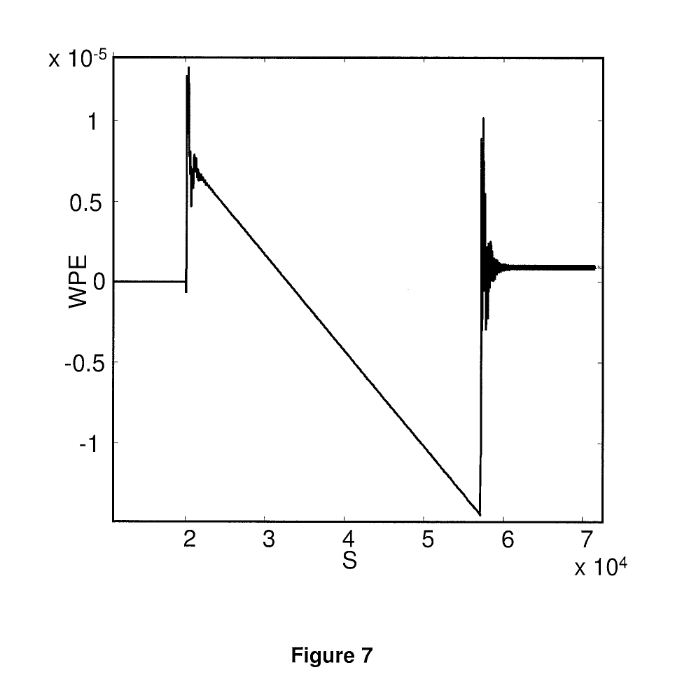

FIG. 6 shows the effect of applying a force to the belt via a disturbance means, e.g. a scraper, on the position of the rollers. If a disturbance means is placed with a particular force on the belt, the tension in the drawn part of the belt between the drive and the disturbance means increases, the tension in the pushed part decreases. The difference between the increase and the decrease corresponds to the extra force of the disturbance means. The actual value of for example the tension increase in the drawn part partially depends upon the stiffness ratio of the drawn and pushed parts. The rollers in the drawn part will experience a quite immediate change in position, and this is greater as the distance to the drive increases i.e. Y colour will experience a greater drift than K colour.

From then the belt runs further, but with a higher tension or stretched condition near the print stations. The lines there will, after renewed relaxation to the normal belt tension, come closer together than before the force was applied with the disturbance means.

At the same belt location Y-lines and K-lines from other moments appear in which the K-lines experience sudden positional changes, the Y-lines were still printed in the force-less period of the disturbance means. Thus a drift in the K-lines with respect to the Y-lines occurs.

The printing process proceeds under increased tension: This can be explained in two ways: either one compares the situation with the situation under normal belt-tension and then the K-lines become closer together or one compares the situation with the situation of the actual belt position, but then through the extra stretching the Y-lines become further apart.

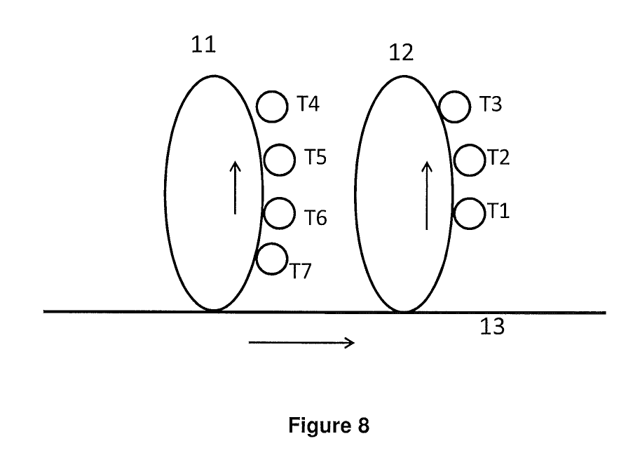

After three stations have been passed [Black(K)→Magenta(M)→Cyan(C)] a sudden shock in Y appears on the paper as a result of the Y-pressure being delayed at that moment (and more than the M drum), the lines are closer to one another. Thereby the registration returns to its original level, see FIG. 7.

This effect of printing on a belt exhibiting varying stretching or tension condition over time, can be extrapolated to any transfer at different locations of toner or ink images constituting a complete print, to a receptor material that is flexible to some extent. The disclosure in the next paragraphs uses these analogies to compare different machine configuration.

### Two Separate Belts:

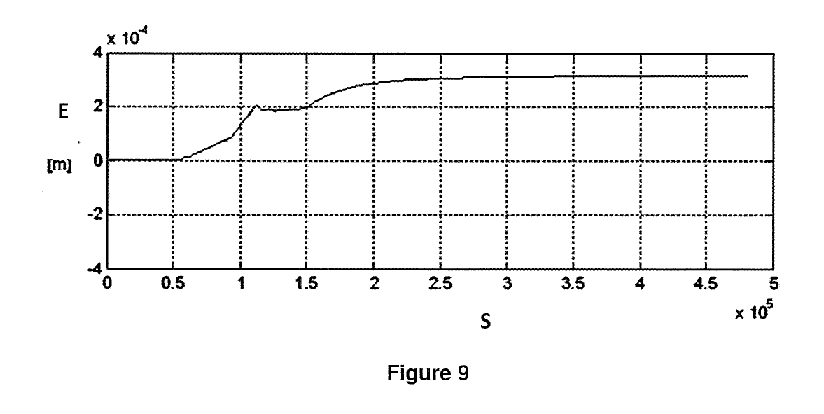

FIG. 8 shows a first (11) and second (12) toner image-collecting devices (seamless belts) with toners T4, T5, T6 and T7; and T1, T2 and T3 respectively in contact with a receptor material (13). For both toner-image collecting devices separately in contact with the receptor material, any registration between two colours that are printed on a different belt will be determined by the receptor material properties. A machine configuration suitable for an industrial market should also allow good registration performance with thin flexible foils. Therefore, a similar simulation is used to evaluate this medium impact on the registration in case of two separate belts.

The physical model now consists of two belt modules, each connected in the transfer point to the receptor material as shown in FIG. 8. A speed-controlled motor drives the receptor material. Disturbance forces can be applied to the belts (representing variable disturbance means forces) and on the receptor material (e.g. force variations in the contact fusing system). The same reasoning regarding the registration as used above resulting in a requirement for a stiff medium, equally applies to the receptor material

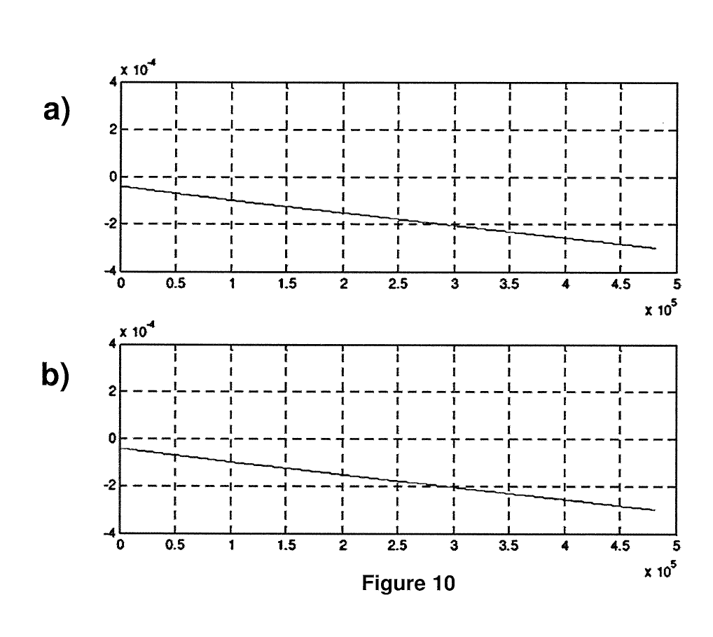

With a sudden increase in the disturbance means (e.g. scraper) force on the belt (or a variation of it over time), the tension in both the belt, but also the receptor material tension changes as through the electrostatic forces, the receptor material also pulls the belt. However, the large time delay between the print stations on the different belts, combined with the low stiffness of some receptor materials, result in a cumulative registration error build up. The registration error within belts is acceptable (10 μm), but with very flexible receptor materials, the registration between the belts, can be as large as 100 μm, see FIG. 9.

Changing the receptor material parameters to a more stiff medium (like cardboard), reduces considerably the registration error between the belts.

Another source of disturbance can be found in the receptor material itself Though an accurate control system of the web itself is indispensable, it is interesting to evaluate the effect of the imperfections of that control system on the two-belt architecture. In the elementary simulation, a step-increase in the force of the contact fuser is applied. The result is a variation in the web tension, but different in each part of the web.

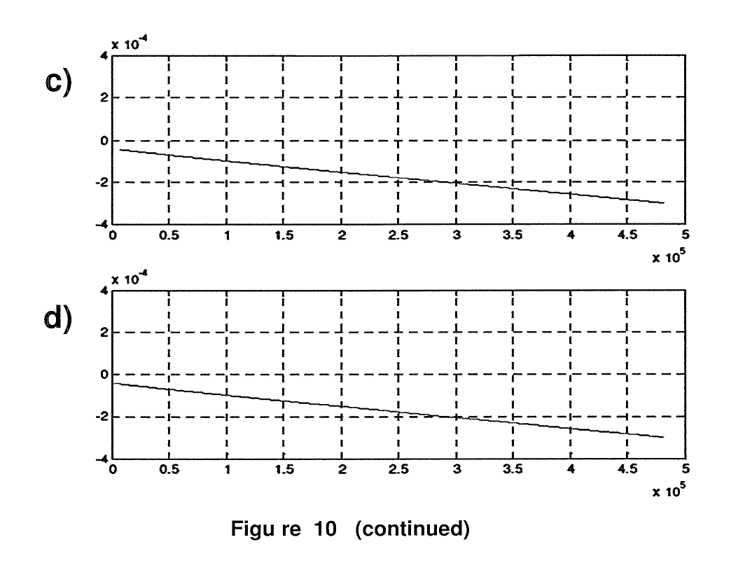

The stress condition of the receptor material at the different belt-receptor material transfer points is also different. The effective distance between the lines becomes therefore different, and the registration error builds up continuously (see the formula (4) above). This is of course not realistic, but indicates an extra concern of the architecture with two separate belts, see FIG. 10.

The architecture with two individual belts in contact with the receptor material at different places is more sensitive in terms of registration errors to variations in web tension, or stiffness parameters of the receptor material, compared to an architecture where all colours are transferred to the receptor material in one single point.

### Two Connected Collecting Devices:

The model has been used to model the effect of a configuration using connected toner image collecting devices, for example two connected toner image collecting devices. In such configurations transfer to the receptor material is confined to a single toner image collecting device. This means that the registration between the colours is already fixed as soon as the last colour is added to the last intermediate member. The final transfer step toward the receptor material cannot change anything to the registration quality; in other words, no variations in speed, tension condition in the receptor material can have any effect on the final registration.

The big advantage of the present invention is therefore its insensitivity to the receptor material properties (without any complicated sensors, actuators etc.) in combination with a limitation in the size, and hence increased manufacturability, of the intermediate collecting devices. Of course the intermediate members still play an important role, but these can be selected and tuned by the engine manufacturer, and will preferably be quite stiff material.

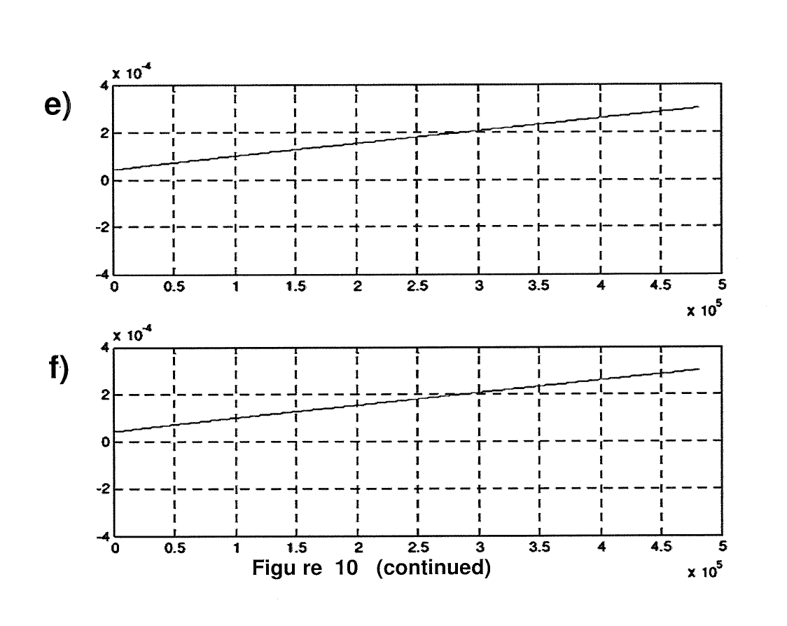

FIG. 11 shows such a configuration with two toner image collecting devices: a first (11) and second (12) toner image-collecting devices (belts) with toners T1, T2 and T3; and T4, T5, T6 and T7 respectively, but unlike the situation in FIG. 8 only the first toner image collecting device transfers toners T1, T2 and T3 to the second toner image collecting device and the second toner image collecting device transfers toners T1 to T7 to the receptor material (13). As expected from this model but surprising in respect of the prior art, it has been found that two connected collecting devices perform better that two non-connected belts proportional to the stiffness of their materials.

### Method of Forming a Multi-Colour Image on a Receptor Material

According to a first aspect of the present invention a method of forming a multi-colour image on a web-fed receptor material (13) is provided with a system comprising an array of at least two toner image-collecting devices (11) with at least a first toner image-collecting device and a final toner image-collecting device optionally with at least one toner image-collecting device in between, said first toner image-collecting device coming into contact with said final collecting device or the next collecting device in the array and the next collecting device either coming into contact with the following collecting device in said array or said final collecting device in said array, each toner-image-collecting device being comprised in a colour unit (60) with at least one image-forming station (14) directly associated therewith that can transfer a toner image to said associated toner image-collecting device, a transfer zone (19) between a collecting device in a particular colour unit and a collecting device directly associated with a different colour unit (60), comprising the steps of: receiving the toner image or images on said first toner image-collecting device in a first colour unit (60); transferring said toner image or toner images on said first toner image-collecting device at a single transfer point either directly or via at least one intermediary toner image-collecting device each in a colour unit (60) to said final toner image-collecting device in said array of at least two toner image-collecting devices directly or indirectly to said receptor material at a single transfer point on one side of said receptor element using a transfer device (18) such that the image transferred in said transfer zone contains the individual images of all image-forming stations in said multiple colour units, wherein at least one of the image-collecting devices (11) is a seamless belt having an overall stiffness in the range of 1×10⁻² to 1×10⁻⁶N/m.

According to a preferred embodiment of the first aspect of the present invention, at least one of said set of electrostatotographic stations comprises at least two electrostatographic stations, with at least three electrostatographic stations being preferred and at least four electrostatographic stations being particularly preferred.

According to a preferred embodiment of the first aspect of the present invention, at least two of said set of electrostatotographic stations comprises at least two electrostatographic stations, with at least three electrostatographic stations being preferred and at least four electrostatographic stations being particularly preferred.

According to an alternative embodiment of the first aspect of the present invention a method of forming a multi-colour image on a receptor material (13) is provided with a system comprising: a set of multiple colour units (60), each comprising: a toner image-collecting device (11), and at least one image-forming station (14) directly associated therewith that can transfer a toner image to said toner image-collecting device, a transfer zone (19) from each collecting device in said set of multiple units to another collecting device in said set of multiple units, wherein the toner image received on said first collecting device is transferred from said first collecting device to said second collecting device via a transfer zone on one collecting device of said set of multiple devices wherein the collected toner image is transferred directly or indirectly to said receptor material using a transfer device (18) such that the image transferred in said transfer zone contains the individual images of all image-forming stations in said multiple colour units.

According to an alternative embodiment of the first aspect of the present invention, a method of forming a multi-colour image on a receptor material with a system is provided comprising at least two image-forming stations wherein for at least one of the image-forming stations the image produced by the image-forming station undergoes at least two electrophotographic transfers and at least one additional transfer before it is placed on the receptor material.

According to another preferred embodiment of the first aspect of the present invention, the toner is a dry electrostatographic toner.

According to another preferred embodiment of the first aspect of the present invention, the toner is a liquid toner, comprising a liquid component and a solid component.

According to another preferred embodiment of the first aspect of the present invention, said seamless belt has an overall stiffness in the range of 1×10⁻³ to 5×10⁻⁶ N/m and preferably from 1×10⁻⁴ to 1×10⁻⁵ N/m. According to a preferred embodiment of the first aspect of the present invention, wherein at least one of the image-collecting devices is a drum.

According to another preferred embodiment of the first aspect of the present invention, at least one device (60) comprises at least two image-forming stations.

According to another preferred embodiment of the first aspect of the present invention, all toner image-collecting devices are seamless belts.

According to another preferred embodiment of the first aspect of the present invention, the seamless belt is of a cast, extruded, multi-layer, woven or non-woven material, the material being selected from rubber (e.g. silicone rubber), polyimide etc.

The receptor element may be paper or plastic, or a label material, where the face of the label material (material in contact with the toner) can be paper or plastic.

According to another preferred embodiment of the first aspect of the present invention, the receptor material is a plastic film selected from the group consisting of polyolefin film (such as polyethylene or polypropylene film) and polyester film (such as polyethylene terephthalate film). The thickness of a plastic receptor material is typically less than 100 μm.

According to another preferred embodiment of the first aspect of the present invention, the receptor material is a label material and the face of the label material is a plastic selected from the group consisting of polyolefin (such as polyethylene or polypropylene) and polyester (such as polyethylene terephthalate).

### Electrostatographic Printer

According to a second aspect of the present invention an electrostatographic printer is provided for forming an image onto a receptor element, which printer comprises: an array of at least two collecting devices with at least a first collecting device and a final collecting device optionally with at least one collecting device in between, said first collecting device in contact with said final collecting device or the next collecting device in the array and the next collecting device either in contact with the following collecting device in said array or said final collecting device in said array, each collecting device being capable of receiving the toner images produced by a set of at least two electrostatographic stations associated therewith via a transfer means for transferring the toner image from each associated image-producing electrostatographic station in said set to said associated collecting device together, if applicable, with the cumulated toner images from the preceding collecting device; each set of electrostatotographic stations comprising:

a) rotatable endless surface means onto which a toner image can be formed,
b) means for forming an electrostatic latent image on the endless surface means and
c) a developing unit for depositing electrostatically charged toner particles onto the electrostatic latent image,
wherein said final collecting device is capable of transferring the cumulated toner images from the directly preceding collecting device together with the toner images received from the set of electrostatographic stations associated with said final collecting device to said receptor element or to an intermediate means from which later the toner image is transferred to the receptor material in which case the image is transferred indirectly to said receptor material; and wherein said printer is capable of printing images with at least five coloured toners at a process speed of greater than 60 mm/s with a registration of better than 100 μm.

According to a preferred embodiment of the second aspect of the present invention an electrostatographic printer is provided for forming an image onto a receptor element, which printer comprises:

i) a first set of at least one toner image-producing electrostatographic stations comprising rotatable endless surface means onto which a toner image can be formed, means for forming an electrostatic latent image on the endless surface means and a developing unit for depositing electrostatically charged toner particles onto the electrostatic latent image;
ii) a first collecting device that is capable of receiving the toner images produced by the electrostatographic stations in the first set of image-producing electrostatographic stations,
iii) transfer means for transferring the toner image from each image-producing electrostatographic station in said first set to said first collecting device,
iv) a second set of at least one toner image-producing electrostatographic stations comprising rotatable endless surface means onto which a toner image can be formed, means for forming an electrostatic latent image on the endless surface means and a developing unit for depositing electrostatically charged toner particles onto the electrostatic latent image;
v) a second collecting device that is capable of receiving the toner images produced by the electrostatographic stations in the second set of image-producing electrostatographic stations,
vi) transfer means for transferring the toner image from each image-producing electrostatographic station in said second set to said second collecting device,
vii) transfer means for transferring the toner image from said first collecting device to said second collecting device,
viii) transfer means for transferring the toner image from said second collecting device directly onto the receptor material or to an intermediate means from which later the toner image is transferred to the receptor material in which case the image is transferred indirectly to the receptor material.

In an electrostatographic based colour printer, the image is formed from differently coloured toners. This toner may be a dry toner or a liquid toner comprising a liquid component and a solid component. For each of different colours in the image, the part of the image that is composed with a particular colour is formed by at least one toner image-forming station (14).

According to another preferred embodiment of the second aspect of the present invention, the printer is capable of printing with at least five coloured toners, with at least seven coloured toners being preferred.

According to another preferred embodiment of the second aspect of the present invention, at least one of said set of electrostatotographic stations comprises at least two electrostatographic stations, with at least three electrostatographic stations being preferred and at least four electrostatographic stations being particularly preferred.

According to another preferred embodiment of the second aspect of the present invention, at least two of said set of electrostatotographic stations comprises at least two electrostatographic stations, with at least three electrostatographic stations being preferred and at least four electrostatographic stations being particularly preferred.

According to another preferred embodiment of the second aspect of the present invention, the printer is capable of printing at a process speed of at least 30 cm/s, with at least 60 cm/s being preferred and 1 m/s being particularly preferred.

According to another preferred embodiment of the second aspect of the present invention, the printer is capable of printing at a process speed of at most 3 m/s.

According to a preferred embodiment of the second aspect of the present invention, the printer is capable of printing with at least five colours with a registration of at most 50 μm.

According to another preferred embodiment of the second aspect of the present invention, the printer is capable of printing with at least seven colours with a registration of at most 100 μm, with a registration of at most 50 μm being preferred.

According to another preferred embodiment of the second aspect of the present invention, at least one toner image-collecting device is a seamless belt, with all toner image-collecting devices being seamless belts being preferred. The seamless belts preferably having an overall stiffness in the range of 1×10⁻² to 1×10⁻⁶ N/m and more preferably from 1×10⁻³ to 5×10⁻⁶ N/m and more preferably from 1×10⁻⁴ to 1×10⁻⁵ N/m. The seamless belt could be polyimide based or could be a multi-layer belt. In another embodiment, the toner image-collecting device is a cylindrical roll or a seamless belt on a cylindrical roll or a blanket on a cylindrical roll.

According to the present invention, a first toner image-collecting device (11) is in contact with a second collecting device (12) in a transfer zone (19). In the transfer zone (19) between the two toner image-collecting devices, the image formed on the first toner image-collecting device (11) is transferred to the second toner image-collecting device (12) using a transfer device (4). On the second toner image-collecting device (12), the image of all of the image-forming electrophotographic stations in contact with the second toner image-collecting device is collected with the image that was formed on the first toner image-collecting device (11).

According to another preferred embodiment, the second toner image-collecting device comes into contact with the receptor material (13) on which the final image is formed. According to another preferred embodiment, the second toner image-collecting device contains the final image, and transfers the final image first to an intermediate means from where it is transferred to the receptor material.

According to another preferred embodiment, there are more than two toner image-collecting devices, of which one toner image-collecting device is in contact with the receptor material (13). The toner image-collecting devices that are not in contact with the receptor material are each in contact with one other toner image-collecting device in a contact zone. In that contact zone, the toner image formed on one toner image-collecting device is transferred to the other toner image-collecting device using electrophotographic transfer. That way, the image on the toner image-collecting devices is transferred from one toner image-collecting device to another toner image-collecting device until finally all single-colour images are collected together on one toner image-collecting device. That toner image-collecting device is in contact with the receptor material or with an intermediate means that is in contact with the receptor material. In that contact, the final image is transferred.

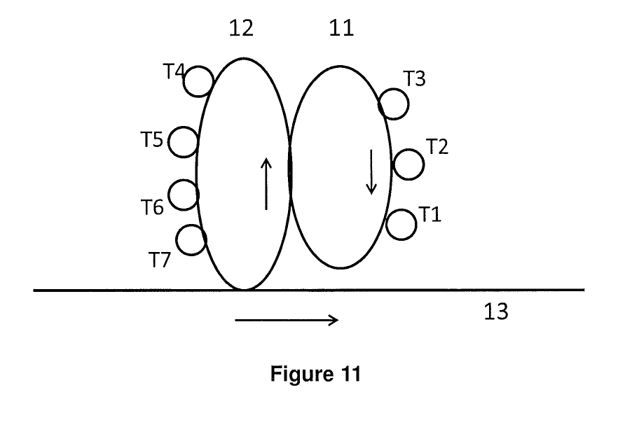

The number of toner image-collecting devices may be more than two. FIG. 13 shows an embodiment of the present invention with three toner image-collecting devices. In the transfer zone (19) between the two toner image-collecting devices, the image formed on the first toner image-collecting device (11) is transferred to the second toner image-collecting device (12). On the second toner image-collecting device (12), the image of all of the image-forming electrophotographic stations in contact with the second toner image-collecting device is collected with the image that was formed on the first toner image-collecting device (11).

In a preferred embodiment of the present invention, the second toner image-collecting device comes into contact with a third toner image-collecting device (21) in a contact zone where the image is transferred to the third toner image-collecting device (21) in a transfer zone (20). On this third toner image-collecting device, again additional image-forming electrophotographic stations add a single-colour image on the toner image-collecting device. Finally, the toner image-collecting device is in contact with the receptor material (13) on which the final image is formed by means of an electrophotographic transfer by means of a transfer device (18).

In another embodiment, the second toner image-collecting device contains the final image, and transfers the final image first to an intermediate means from where it is transferred to the receptor material, which can be called an indirect transfer to the receptor material.

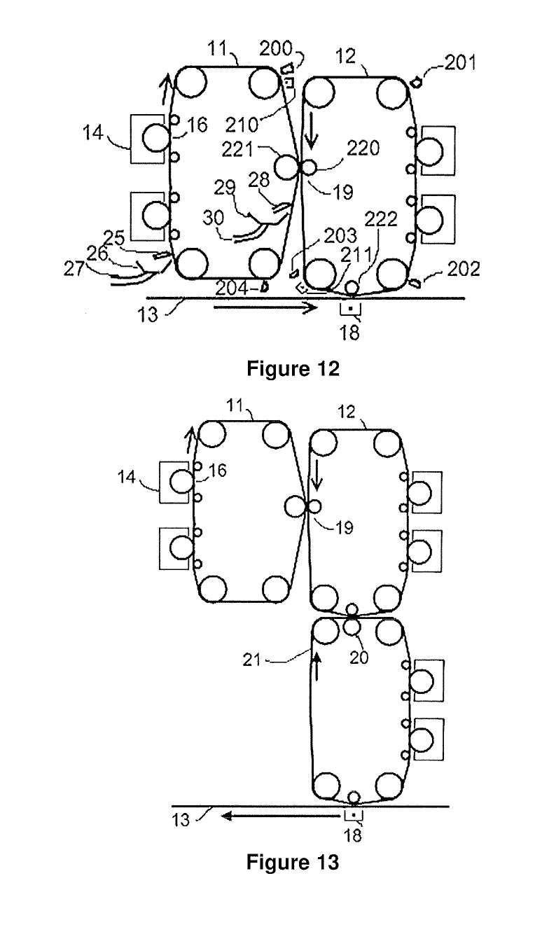

FIG. 14 shows an embodiment of the present invention with three toner image collection devices with some advantages over the setup in FIG. 13. In the transfer zone (19) between the two toner image-collecting devices, the image formed on the first toner image-collecting device (11) is transferred to the second toner image-collecting device (12). On the second toner image-collecting device (12), the image of all of the image-forming electrophotographic stations in contact with the second toner image-collecting device is collected with the image that was formed on the first toner image-collecting device (11).

In the embodiment illustrated in FIG. 14, the toner image-collecting device (12) comes into contact with a third toner image-collecting device (40) in a contact zone where the image is transferred from the third toner image-collecting device (40) to the second toner image-collecting device (12). This results in an image that contains all images of all image-forming electrophotographic stations. The resulting image can be transferred to the receptor material (13) in a transfer zone (42) with the receptor material.

The advantage of the embodiment shown in FIG. 14 over the embodiment in FIG. 13 is that the maximum number of times any single colour image is transferred before it is put on the receptor material is one less, since every transfer potentially results in image degradation or incomplete transfer, the embodiment in FIG. 14 is to be preferred.

In the invention it is always so that there is always minimum 1 image-forming electrophotographic station for which the image formed by the image-forming electrophotographic station is transferred at least 3 times of which at least two times electrophotographically before it reaches the receptor material:
one electrophotographic transfer from the image-forming electrophotographic station to a first toner image-collecting device in a transfer zone (16)
one electrophotographic transfer from the first toner image-collecting device to a second toner image-collecting device (19)
one transfer from the second or another toner image-collecting device to the receptor material (13).

There might be additional transfers involved, e.g. if there is an additional drum or belt in between the last collecting device and the receptor material e.g. to avoid wear of the collecting device. The receptor material (13) on which the final image is formed can be a web or can be sheets.

In a preferred embodiment, at least one of the image-forming electrophotographic stations can be decoupled from the toner image-collecting devices when not used. This has the advantage that the components of the image-forming electrophotographic stations do not wear when they are not used.

In a preferred embodiment, the toner image-collecting devices can be decoupled in the transfer zone between the toner image-collecting devices. The goal of decoupling is that in the case of not using any of the image-forming electrophotographic stations that are coupled to a specific toner image-collecting device, also the toner image-collecting device does not wear when the printing device is operating.

In a preferred embodiment, the toner image-collecting device that is in contact with the receptor material can be decoupled from the receptor material.

The aim is that the image-forming electrophotographic stations can be running and tested without receptor material being consumed.

In a preferred embodiment, there is cleaning on the outside of each toner image-collecting device. This cleaning ensures the toner image-collecting device is free of residual toner before a new image is transferred to it. This cleaning can consist of a scraping blade (25), a collecting device (26) and a hose (27) in which a pressure is maintained lower than the ambient pressure, resulting in a suction so that the toner that is removed by the scraping blade (25) from outside of the toner image-collecting device. Another embodiment uses a rotating cleaning brush to remove the residual toner.

In a preferred embodiment, there is a cleaning on the inside of each image-collecting device. This cleaning ensures the toner image-collecting device does not accumulate toner on the inside. This is needed because accumulating toner can diminish the transfer efficiency at the place where images are transferred from or transferred to the toner image-collecting device, resulting in a locally lighter area. This cleaning can consist of a scraping blade (28), a collecting device (29) and a hose (30) in which a pressure is maintained lower than the ambient pressure, resulting in a suction so that the toner that is removed by the scraping blade (28) from inside of the toner image-collecting device.

In a preferred embodiment, the electrical potential applied to the transfer devices is influenced by a control loop. This control loop uses measurements performed by measurement devices that measure well known images on the toner image-collecting devices. These measurement devices can be e.g. densitometers. In another embodiment, where the toner image-collecting devices are reflective, the measurement devices use the amount of reflected light to estimate how much toner is present on the toner image-collecting device.

In a preferred embodiment, there is a measurement device (200) such as, for example, a densitometer to measure the transfer efficiency from the image-forming electrophotographic stations to the toner image-collecting device. Such a measurement device (201) can not only be on the first toner image-collecting device, but also on other toner image-collecting devices. Using these measurement devices, a well-known image such as, for example, a small patch produced only by one image-forming electrophotographic station can be measured and be used as the feed to a control loop that steers the voltages applied in the transfer charge device (4).

In a preferred embodiment, there is a measurement device (203) such as, for example, a densitometer to measure the transfer efficiency from one toner image-collecting device to another toner image-collecting device. Using these measurement devices, a well-known image such as, for example, a small patch produced only by one image-forming electrophotographic station can be measured and be used as the feed to a control loop that steers the voltages applied in the transfer charge device in the transfer zone (19) between the toner image-collecting devices.

In a preferred embodiment, there is a measurement device (204) such as, for example, a densitometer to measure residual toner on a toner image-collecting device after the transfer to a second toner image-collecting device. Using this measurement device, a well-known image such as, for example, a small patch produced only by one image-forming electrophotographic station can be measured and be used as the feed to a control loop that steers the voltages applied in the transfer charge device in the transfer zone (19) between the toner image-collecting devices.

In a preferred embodiment, there is a measurement device (202) such as, for example, a densitometer to measure residual toner on a toner image-collecting device after the transfer to the receptor material. Using this measurement device, a well-known image such as, for example, a small patch produced only by one image-forming electrophotographic station can be measured and be used as the feed to a control loop that steers the voltages applied in the transfer charge device (18) that does the toner transfer between a toner image-collecting device and the receptor material.

According to a preferred embodiment, the transfer zone (19) where the transfer is performed from one toner image-collecting device (11) to another toner image-collecting device (12) is constructed this way that the transfer only happens when the toner image-collecting devices are touching each other. This means there should be no large area where the image-collecting devices are almost touching. Such an area must be avoided because in such an area, the toner can be attracted enough so that it crosses the small gap between the toner image-collecting devices, and actually transfer over a certain distance, resulting in a disturbance of the image.

One way to avoid a larger area where the image-collecting devices are almost touching is to make the roller (220) on the inside of one toner image-collecting device substantially smaller than the roller (221) on the inside of the other toner image-collecting device.

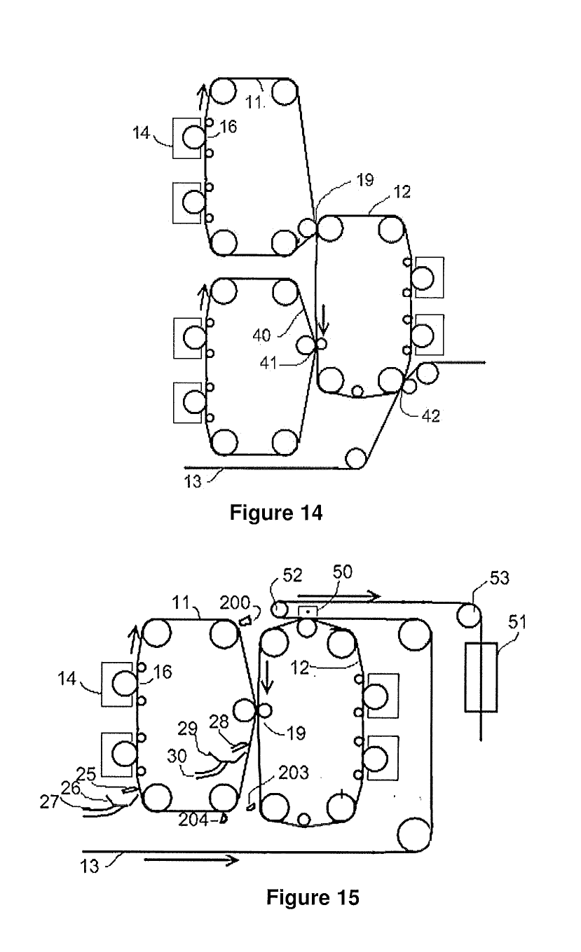

In another embodiment, such as that shown in FIG. 15, the receptor material contacts a toner image-collecting device in a transfer zone, where the toner image-collecting device is below the receptor material during the contact zone. In this way, the receptor material leaves the transfer zone with a multi-colour image at a higher distance to the bottom of the machine. A higher distance has the advantage that with a roll (52) and possibly a second roll (53), where these rollers don't touch the imaged side of the receptor material, the material can be led to a fusing device (51). This fusing device does not add additional height to the machine since the receptor material has turned with the rollers. The fact that the rollers don't touch the imaged side of the receptor material is especially important since at that moment, the image is not fused yet, and any mechanical contact can disturb the formed image.

According to a preferred embodiment, there can be charging corona's (210) before the transfer from one toner image-collecting device to another. This can help to induce a more equal charge to all toner particles that are present on the toner image-collecting device, and result in a better image transfer.

In a preferred embodiment, there can be a charging corona (211) before the transfer from a toner image-collecting device to the receptor material (13). This can help to induce a more equal charge to all toner particles that are present on the toner image-collecting device, and result in a better image transfer to the receptor material.

In a preferred embodiment, the roller (222) that is on the inside of the toner image-collecting device at the transfer zone with the receptor material can also be set to a certain electrical potential. This helps the image transfer to the receptor material with certain materials that contain e.g. a metalized layer. In such media, the layer that is metalized shields the toner on the toner image-collecting device from the transfer device (18), resulting in a poor transfer. To remedy this, an electrical potential applied to the roller (222) on the inside of the toner image-collecting device creates an electrical field that pushes the toner towards the receptor material, with a good image transfer as a result.

It is to be understood that although preferred embodiments, specific constructions and configurations, as well as materials, have been discussed herein for devices according to the present invention, various changes or modifications in form and detail may be made without departing from the scope and spirit of this invention. For example, any formulas given above are merely representative of procedures that may be used. Steps may be added or deleted to methods described within the scope of the present invention.

We claim:

1. A method of forming a multi-colour image on a web-fed receptor material with a system comprising an array of at least two toner image-collecting devices with at least a first toner image-collecting device and a final toner-image-collecting device optionally with at least one collecting device in between, said first toner-image-collecting device coming into contact with said final toner-image-collecting device or the next toner-image-collecting device in the array and the next toner-image-collecting device either coming into contact with following toner-image-collecting device in said array or said final toner-image-collecting device in said array, each toner-image-collecting device being comprised in a colour unit with at least one image-forming station directly associated therewith that can transfer a toner image to said associated toner image-collecting device, a transfer zone between a toner image-collecting device in a particular colour unit and a toner image-collecting device directly associated with a different colour unit, comprising the steps of: receiving a toner image or images on said first toner image-collecting device in a first colour unit; transferring said toner image or toner images on said first image-collecting device at a single transfer point either directly or via at least one intermediary toner image-collecting devices each in an colour unit to said final toner image-collecting device in a final colour unit via transfer zones between said array of at least two toner-image collecting devices; and transferring all the toner image or images collected on said final toner-image collecting device in said array of at least two image-collecting devices directly or indirectly to said receptor material at a single transfer point at one side of said receptor element using a transfer device such that the collected toner image transferred from said final toner image-collecting device using said transfer device contains the individual images from all image-forming stations in said multiple colour units, wherein at least one of the image-collecting devices is a seamless belt, said at least one seamless belt having an overall stiffness in the range of 1×10⁻² to 1×10⁻⁶N/m.

2. The method according to claim 1, wherein at least one of said sets of electrostatotographic stations comprises at least two electrostatographic stations, with at least three electrostatographic stations being preferred.

3. The method according to claim 1, wherein at least two of said sets of electrostatotographic stations comprises at least two electrostatographic stations, with at least three electrostatographic stations being preferred.

4. The method according to claim 1, wherein at least three of said sets of electrostatotographic stations comprises at least two electrostatographic stations.

5. The method according to claim 1, wherein the toner is a dry electrostatographic toner.

6. The method according to claim 1, wherein the toner is a liquid toner, comprising a liquid component and a solid component.

7. The method according to claim 1, wherein at least one of the image-collecting devices is a drum.

8. The method according to claim 1, wherein at least one colour unit comprises at least two image-forming stations.

9. The method according to claim 1, wherein said printer prints images with at least five coloured toners at a process speed of greater than 60 mm/s with a registration of better than 100 μm.

10. An electrostatographic printer for forming an image onto a receptor element, which printer comprises: an array of at least two toner image-collecting devices with at least a first collecting device and a final collecting device optionally with at least one collecting device in between, said first collecting device coming into contact with said final collecting device or the next collecting device in the array and the next collecting device either coming into contact with the following collecting device in said array or said final collecting device in said array,
each collecting device being capable of receiving the toner images produced by a set of at least two electrostatographic stations directly associated therewith via a transfer means for transferring the toner image from each directly associated image-producing electrostatographic station in said set to said directly associated collecting device together, if applicable, with the cumulated toner images from the preceding collecting device; each set of electrostatographic stations comprising:
a) rotatable endless surface means onto which a toner image can be formed,
b) means for forming an electrostatic latent image on the endless surface means and
c) a developing unit for depositing electrostatically charged toner particles onto the electrostatic latent image,
wherein said final collecting device is capable of transferring the cumulated toner images from the directly preceding collecting device together with the toner images received from the set of electrostatographic stations directly associated with said final collecting device to said receptor element or to an intermediate means from which later the toner image is transferred to the receptor material in which case the image is transferred indirectly to said receptor material; and wherein said printer is capable of printing images with at least five coloured toners at a process speed of greater than 60 mm/s with a registration of better than 100 μm.

11. The electrostatographic printer for forming an image onto a receptor element according to claim 10, wherein at least one of said sets of electrostatotographic stations comprises at least two electrostatographic stations, with at least three electrostatographic stations being preferred.

12. The electrostatographic printer for forming an image onto a receptor element according to claim 10, wherein at least two of said sets of electrostatotographic stations comprises at least two electrostatographic stations, with at least three electrostatographic stations being preferred.

13. The electrostatographic printer for forming an image onto a receptor element according to claim 10, wherein said printer is capable of using a liquid toner comprising a liquid component and a solid component.

14. The electrostatographic printer for forming an image onto a receptor element according to claim 10, wherein said printer is capable of using a solid toner.

15. The electrostatographic printer for forming an image onto a receptor element according to claim 10, wherein at least one of said collecting devices is a seamless belt.

16. The electrostatographic printer for forming an image onto a receptor element according to claim 10, wherein said seamless belt has an overall stiffness in the range of 1×10⁻² to 1×10⁻⁶ N/m.
